(19) United States
(12) Patent Application Publication
(10) Pub. No.: US 2013/0002027 A1
(43) Pub. Date: Jan. 3, 2013

(54) UNINTERRUPTIBLE POWER SUPPLY

(75) Inventors: Dachuan Yu, Normal, IL (US); James David Siegle, Washington, IL (US); Mahesh Sitaram Illindala, Dunlap, IL (US); Mark Edward Hartman, Peoria, IL (US); Gregory Jay Speckhart, Peoria, IL (US)

(73) Assignee: Caterpillar Inc.

(21) Appl. No.: 13/174,071

(22) Filed: Jun. 30, 2011

(51) Int. Cl. H02J 9/06; H02J 9/00

(52) U.S. Cl. 307/66; 307/64

(57) ABSTRACT

An uninterruptible power supply includes an input and an output. The uninterruptible power supply may include a first power path between the input and the output. The uninterruptible power supply may also include a second power path between the input and the output. The second power path may include a rectifier and an inverter. The uninterruptible power supply may also include controls configured to operate the uninterruptible power supply to supply electricity to the output. In controlling the uninterruptible power supply, the controls may selectively operate in first mode by transmitting electricity from the inlet to the outlet via the first power path while operating the inverter to condition at least one characteristic of electricity at the output. The controls may also selectively operate the uninterruptible power supply in a second mode by transmitting electricity from the input to the output via the second power path.

### TECHNICAL FIELD

The present disclosure relates to electrical power supplies and, more particularly, to uninterruptible power supplies.

### BACKGROUND

Many systems include one or more electrical power loads and a primary electrical power source for those electrical loads. In such systems, the primary electrical power source may sometimes fail to provide power for various reasons. To help ensure that the electrical power loads continue to receive power in the event of the primary electrical power source failing, many systems include an uninterruptible power supply connected to the primary electrical power source and the electrical power load.

For example, U.S. Pat. No. 7,372,177 to Colombi et al. (“the '177 patent”) discloses an uninterruptible power supply connected to an electrical power source and an electrical power load. The uninterruptible power supply of the '177 patent includes a first feed path for supplying power to the load and a second feed path for supplying power to the load. The first feed path transmits AC electricity from an AC power source to the load. The second feed path extends in parallel to the first feed path and is operable to condition the electricity from an AC power source before supplying it to the load. The second feed path includes a rectifier connected in series with an inverter. The second feed path supplies electricity to the load by using the rectifier and the inverter to convert electricity provide by the power source from AC current to DC current and back to AC current.

To supply power to the load when the primary power source fails, the uninterruptible power supply of the '177 patent includes a battery connected to the inverter of the second feed path. When failure of the primary power source is detected, electricity is transmitted from the battery to the inverter, and the inverter uses the electricity from the battery to supply power to the load.

The '177 patent discloses using the first feed path to supply electricity to the power load sometimes, while using the second feed path to supply electricity to the power load at other times. When supplying electricity to the load with the second feed path, the uninterruptible power supply of the '177 patent operates the inverter to convert DC electricity into desired AC electricity for supply to the load. However, when supplying electricity via the first feed path, the uninterruptible power supply of the '177 patent does not operate the inverter until it is determined to switch from the first feed path to the second feed path. Thus, once it is determined to switch from the first feed path to the second feed path, bringing the inverter online takes some time.

Although the '177 patent discloses an uninterruptible power supply with two feed paths alternately used to supply a load, certain disadvantages may persist. For example, the delay associated with bringing the inverter online when switching from the first feed path to the second feed path may undesirably prolong the transition and/or disturb the supply of electricity to the load.

The disclosed embodiments may solve one or more of the foregoing problems.

### SUMMARY

One disclosed embodiment relates to an uninterruptible power supply. The uninterruptible power supply may include an input and an output. The uninterruptible power supply may include a first power path between the input and the output. The uninterruptible power supply may also include a second power path between the input and the output. The second power path may include a rectifier and an inverter. The uninterruptible power supply may also include controls configured to operate the uninterruptible power supply to supply electricity to the output. In controlling the uninterruptible power supply, the controls may selectively operate in a first mode by transmitting electricity from the inlet to the outlet via the first power path while operating the inverter to condition at least one characteristic of electricity at the output. The controls may also selectively operate the uninterruptible power supply in a second mode by transmitting electricity from the input to the output via the second power path.

Another embodiment relates to an uninterruptible power supply. The uninterruptible power supply may include an input and an output. The uninterruptible power supply may include a first power path between the input and the output. The uninterruptible power supply may also include a second power path between the input and the output. The second power path may include an inverter and a rectifier. The uninterruptible power supply may also include controls configured to control the uninterruptible power supply to supply electricity to the output. In controlling the uninterruptible power supply, the controls may selectively operate in a first mode by transmitting electricity from the inlet to the outlet via the first power path. The controls may also selectively operate in a second mode by transmitting electricity from the inlet to the outlet via the second power path. Additionally, the controls may be configured to receive an operator request to switch between the first mode and the second mode, and switch between the first mode and the second mode in response to the operator request.

A further embodiment relates to a method of operating an uninterruptible power supply. The method may include selectively operating the uninterruptible power supply in a first mode, including supplying electricity from an input of the uninterruptible power supply to an output of the uninterruptible power supply via a first power path. The method may also include selectively operating the uninterruptible power supply in a second mode, including supplying electricity from the input to the output via a second power path, including supplying electricity from the input to a rectifier, supplying electricity from the rectifier to an inverter, and supplying electricity from the inverter to the output. Additionally, the method may include receiving an operator request to switch between the first mode and the second mode, and switching between the first mode and the second mode in response to the operator request.

### BRIEF DESCRIPTION OF THE DRAWINGS

FIG. 1 illustrates an uninterruptible power supply according to one disclosed embodiment connected to a power load and a power source.

### DETAILED DESCRIPTION

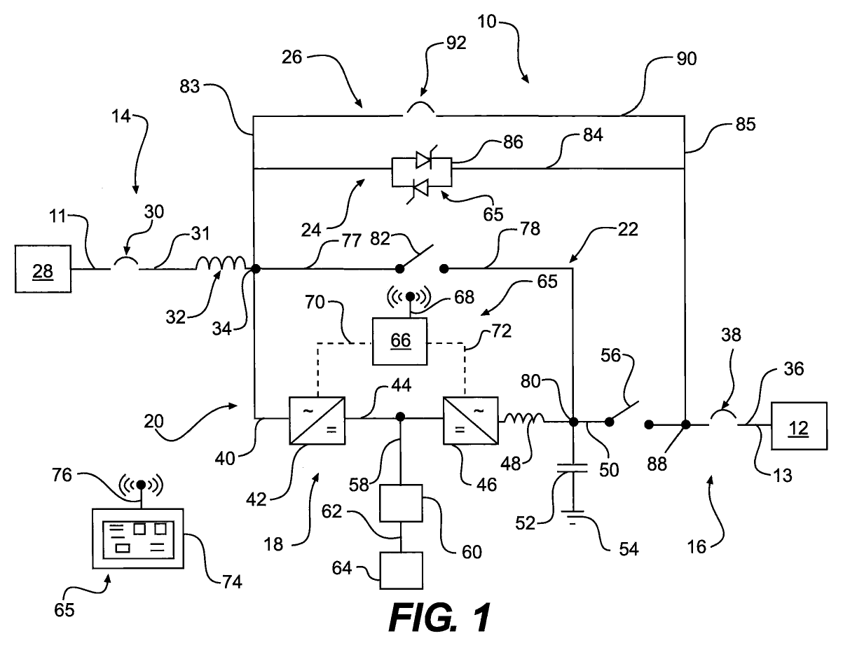

FIG. 1 illustrates an uninterruptible power supply 10 according to the present disclosure connected to an electrical power load 12 and a primary electrical power source 28. Power load 12 may include one or more electrical components of any type that consume electricity. In some embodiments, the one or more electrical components of power load 12 may consume AC electricity. For example, power load 12 may include one or more electrical components that consume AC electricity of 120 or 240 volts and 50 or 60 Hertz. Additionally, in some embodiments, power load 12 may include one or more components for further transmitting electricity to various electrical devices or users. For example, in some embodiments power load 12 could be a micro-grid configured to transmit electricity to various electrical devices or users.

Power source 28 may include any component or components configured to produce power. In some embodiments, power source 28 may include one or more components configured to produce electricity, including DC electricity or AC electricity. For example, power source 28 may include an electrical utility system. Additionally or alternatively, power source 28 may include one or more electric generator units, such as an engine drivingly connected to an electric generator. Such generator units may include a backup generator, such as a diesel generator, intended for use if a primary source of power becomes unavailable. Furthermore, in some embodiments, power source 28 may include an engine. Such an engine may drive a variable-speed generator to produce electricity.

Uninterruptible power supply 10 may include an input side 14 with an input 11 for receiving electricity, an output side 16 with an output 13 for supplying electricity, a center section 18 for transmitting electricity between input side 11 and output 13, and controls 65 for controlling the flow of electricity between input 11 and output 13. Input side 14 may include a power line 31 extending from input 11 to an input node 34. Power line 31 may include a circuit breaker 30 configured to open automatically if the magnitude of electric current in power line 31 rises above a certain level. This may help protect uninterruptible power supply 10, power source 28, and power load 12 from damage due to an over-current condition. Power line 31 may also include an inductor 32.

Output side 16 may include a power line 36 extending from an output node 88 to output 13. Similar to power line 31, power line 36 may include a circuit breaker 38 configured to open automatically in response to electric current in power line 36 rising above a certain level. This may help further protect uninterruptible power supply 10, power source 28, and power load 12 from damage due to an over-current condition. Circuit breakers 30 and 38 may have a normally closed state, allowing transmission of electricity through power lines 31 and 36 unless and until an over-current condition occurs.

Center section 18 may include multiple paths for feeding electricity to output 13. For example, in some embodiments, center section 18 may include a double-conversion feed path 20, a line-interactive feed path 22, an emergency feed path 24, and a maintenance feed path 26.

Double-conversion feed path 20 may include a power line 40 extending from input node 34, a rectifier 42, a power line 44 extending from rectifier 42, an inverter 46, an inductor 48, a power line 50, and a switch 56 connected to output node 88. Rectifier 42 may be any type of active or passive device configured to receive AC electricity from power line 40 and supply DC electricity to power line 44. In some embodiments, rectifier 42 may be an active device with controllable switching elements such as IGBTs or MOSFETs. Inverter 46 may be any type of device operable to receive DC electricity from power line 44 and supply AC electricity to inductor 48 and power line 50. In some embodiments, inverter 46 may also be operable to transmit power in the opposite direction, i.e., from power line 50 to power line 44. Specifically, inverter 46 may be operable to receive AC electricity from power line 50 and supply DC electricity to power line 44. Inverter 50 may, for example, include controllable switching elements such as IGBTs or MOSFETs for converting between DC and AC electricity. Switch 56 may be any type of component operable to selectively connect power line 50 to power line 36.

Line-interactive feed path 22 may be connected between input node 34 and output power line 36 in parallel to double-conversion feed path 20. Line-interactive feed path 22 may include a power line 77, a switch 82, a power line 78, power line 50, and switch 56. Power line 78 may connect to power line 50 at a node 80. Switch 82 may include any components operable to selectively connect power line 77 to power line 78.

Connected to power line 50 of double-conversion feed path 20 and line-interactive feed path 22, uninterruptible power supply 10 may include a capacitor 52 and a ground 54. These components may connect to power line 50 via node 80. Capacitor 52 may serve to help smooth undesired fluctuations in the electricity within power line 50.

Maintenance feed path 26 may include a power line 83 connected to input node 34, a power line 90 extending from power line 83, and a power line 85 connecting to output power line 36 via output node 88. Additionally, maintenance feed path 26 may include a circuit breaker 92 in power line 90. Circuit breaker 92 may be configured to manually open or close power line 90 to open or close maintenance feed path 26. Circuit breaker 92 may be normally open to hold maintenance feed path 26 open.

Emergency feed path 24 may include power line 83, a power line 84, and power line 85. Additionally, emergency feed path 24 may include a static switch 86 in power line 84. Static switch 86 may be a fast-acting switch operable to selectively open or close power line 84, thereby opening or closing emergency feed path 24. Static switch 86 may be normally open to hold emergency feed path 24 open.

To serve as backup power for load 12, uninterruptible power supply 10 may include an energy storage device 64 connected to power line 44 by a power line 62, a power regulator 60, and a power line 58. Energy storage device 64 may include any components operable to receive energy in the form of electricity from power line 62, store at least a portion of that energy, and return energy to power line 62 in the form of electricity. For example, energy storage device 64 may include one or more batteries and/or capacitors. Additionally or alternatively, energy storage device 64 may include an electric motor/generator drivingly connected to a flywheel. Furthermore, in some embodiments, energy storage device 64 may include one or more fuel cells and/or one or more renewable photovoltaic panels.

Power regulator 60 may include any components operable to control one or more aspects of transmission of electricity between power line 44 and energy storage device 64. In some embodiments, power regulator 60 may be a DC-to-DC power converter configured to control whether and in which direction electricity flows between power line 44 and energy storage device 64. Power regulator 60 may include one or more active switching devices, such as IGBTs and/or MOSFETs for controlling whether and in which direction electricity flows between power line 44 and energy storage device 64. In some embodiments, power regulator 60 may be configured to change the voltage of electricity flowing between power line 44 and energy storage device 64, such as by performing chopping operations.

While FIG. 1 illustrates each of the various power lines of uninterruptible power supply 10 with a single line, it will be understood that various of these power lines may include multiple conductors, such as for carrying multiple-phase electricity. For example, power lines 31, 36, 40, 50, 77, 78, 83, 84, 85, and 90 may, in some embodiments, each have three conductors for carrying three-phase AC electricity.

Controls 65 of uninterruptible power supply 10 may include many of the components already discussed. For example, controls 65 may include rectifier 42, inverter 46, circuit breakers 30, 38, and 92, and switches 56, 82, and 86. Additionally, controls 65 may include various other components. For example, controls 65 may include one or more control components operable to control one or more aspects of the operation of the foregoing components. In some embodiments, controls 65 may include a controller 66 configured to control the operation of various other components of uninterruptible power supply 10. Controller 66 may include any components operable to execute one or more control algorithms. In some embodiments, controller 66 may include one or more microprocessors (not shown) and one or more memory devices (not shown).

Controller 66 may be operatively connected to various components of uninterruptible power supply 10. As FIG. 1 shows, in some embodiments, controller 66 may be operatively connected to rectifier 42 and inverter 46 via communication lines 70 and 72, respectively. By way of communication line 70, controller 66 may control whether rectifier 42 is active or inactive. Additionally, when rectifier 42 is active, controller 66 may control rectifier 42 to control whether rectifier 42 supplies electricity to power line 44 and, if so, at what voltage and/or current the electricity is supplied to power line 44. By way of communication line 72, controller 66 may control whether inverter 46 is active or inactive. Additionally, when inverter 46 is active, controller 66 may control inverter 46 to influence various aspects of the electricity in power line 44 and/or power line 50, as discussed in greater detail below. Controller 66 may also be operatively connected to switches 56, 82, 86 and circuit breaker 92, so that controller 66 may control whether each of these components has an open or closed operating state. Additionally, controller 66 may be operatively connected to power regulator 60 and/or energy storage device 64 in a manner allowing controller 66 to control whether electricity is exchanged between power line 44 and energy storage device 64 and, if so, the direction and magnitude of this electricity.

Controller 66 may also be operatively connected to various other components, including sources of information. For example, controls 65 may also include an operator interface 74 communicatively linked to controller 66. Operator interface 74 may include any component or components with which an operator of uninterruptible power supply 10 may monitor one or more aspects of operation and/or communicate operating requests to controls 65. In some embodiments, operator interface 74 and controller 66 may be wirelessly linked to one another via a transceiver 76 of operator interface 74 and a transceiver 68 of controller 66. Additionally or alternatively, operator interface 74 and controller 66 may be communicatively linked to one another via hard communication lines.

Controller 66 may also be connected to various sources of information about the operation of uninterruptible power supply 10. For example, in some embodiments, controller 66 may be connected to sensors that inform controller 66 of the voltage and/or current in various power lines, such as power lines 31, 36, 40, 44, 50, 58, 62, 77, 78, 83, 84, 85, and 90.

Uninterruptible power supply 10 is not limited to the configuration shown in FIG. 1. For example, uninterruptible power supply 10 may omit various of the components shown in FIG. 1 and/or include additional components not shown in FIG. 1. In some embodiments, center section 18 of uninterruptible power supply 10 may omit one or more of double-conversion feed path 20, line-interactive feed path 22, emergency feed path 24, and maintenance feed path 26. Additionally or alternatively, uninterruptible power supply 10 may include additional feed paths in center section 18. Furthermore, uninterruptible power supply 10 may omit one or more of the components within one of the feed paths and/or include additional components. For example, uninterruptible power supply 10 may omit switch 56 from double-conversion feed path 20 and/or include additional switches within double-conversion feed path 20. Uninterruptible power supply 10 may also have different configurations of controls 65. For example, controls 65 may have multiple controllers in place of controller 66. Additionally or alternatively, controls 65 may include hardwired logic circuitry to perform some control functions of uninterruptible power supply 10.

Additionally, uninterruptible power supply 10 may include multiple inputs and/or multiple outputs. This may allow connection of alternate power sources and/or alternate loads to uninterruptible power supply 10. For example, uninterruptible power supply 10 may have one input connected to a utility grid and an alternate input connected to a backup generator.

### INDUSTRIAL APPLICABILITY

Uninterruptible power supply 10 may have use wherever it may prove desirable to have a backup source of power for power load 12. During operation of uninterruptible power supply 10, electricity may be transmitted to output 13 via one or more of double-conversion feed path 20, line-interactive feed path 22, emergency feed path 24, and maintenance feed path 26. In some embodiments, controls 65 may control which of these feed paths transmits electricity based at least in part on inputs from an operator. For example, operator interface 74 may have provisions with which an operator can communicate a desire to operate in a line-interactive mode or a double-conversion mode. In such embodiments, if the operator has indicated a desire for operation in line-interactive mode, controls 65 may operate uninterruptible power supply 10 to supply electricity via line-interactive feed path 22. On the other hand, when an operator has indicated a desire for operation in double-conversion mode, controls 65 may operate uninterruptible power supply 10 to supply electricity via double-conversion feed path 20.

To operate uninterruptible power supply 10 to supply electricity via line-interactive feed path 22, controls 65 may control switches 82 and 56 to their closed operating states. This may allow electricity from power source 28 to flow through power line. 31, power line 77, switch 82, power line 78, power line 50, switch 56, and power line 36 to output 13. The electricity transmitted in this manner through line-interactive feed path 22 may be, for example, AC electricity.

While operating uninterruptible power supply 10 in line-interactive mode, controls 65 may maintain inverter 46 active. Controls 65 may use inverter 46 to serve various purposes during operation in line-interactive mode. In some embodiments and/or circumstances, controls 65 may use inverter 46 to condition one or more aspects of the electricity supplied to output 13 during operation in line-interactive mode. For example, controls 65 may monitor the magnitude of voltage and/or current at output 13 and operate inverter 46 to adjust the voltage or current toward desired levels. This may involve operating inverter 46 to boost the voltage and/or current at output 13 when controls 65 determine that the voltage or current drops below desirable levels. Conversely, when the voltage and/or current at output 13 rises above desirable levels during line-interactive mode, controls 65 may operate inverter 46 to decrease the voltage and/or current at output 13.

When boosting and/or decreasing the voltage and/or current at output 13, inverter 46 may exchange power with energy storage device 64 via power line 44, power line 58, power regulator 60, and power line 62. During such operation in line-interactive mode, controls 65 may also monitor the energy storage level of energy storage device 64. For example, in embodiments where energy storage device 64 includes a battery, controls 65 may monitor the charge level of the battery. Depending on the energy storage level of the energy storage device 64, controls 65 may operate inverter 46 to direct power from line-interactive path 22 to energy storage device 64 to increase its energy storage level.

When operating in line-interactive mode, controls 65 may maintain rectifier 42 in various states. In some embodiments and/or circumstances, controls 65 may refrain from operating rectifier 42 to transmit electricity from power line 40 to power line 44 during some or all portions of line-interactive mode. For example, in some embodiments, controls 65 may maintain rectifier 42 inactive during all operation in line-interactive mode.

When operating in line-interactive mode, if an operator uses operator interface 74 to communicate a desire to operate in double-conversion mode, controls 65 may switch from supplying electricity via line-interactive feed path 22 to supplying electricity via double-conversion feed path 20. To do so, controls 65 may activate rectifier 42 to begin supplying electricity from power line 40 to power line 44. With rectifier 42 supplying electricity to power line 44, controls 65 may operate inverter 46 to receive electricity from power line 44 and take over the supply of electricity to power line 50 and output power line 36. Concomitantly, controls 65 may control line-interactive feed path 22 to cease supplying electricity to power line 50. This may involve controls 65 opening switch 82 to open line-interactive feed path 22.

With the switch to double-conversion mode made, uninterruptible power supply 10 may supply power to output 13 by supplying electricity from power source 28, through power line 31, inductor 32, power line 40, rectifier 42, power line 44, inverter 46, inductor 48, power line 50, switch 56, and power line 36. During such operation, rectifier 42 may receive AC electricity supplied to power line 40 by power source 28, and rectifier 42 may supply DC electricity to power line 44. Inverter 46 may receive DC electricity from power line 44 and supply AC electricity to output 13 via inductor 48, power line 50, switch 56, and power line 36.

Additionally, during double-conversion mode, controls 65 may also monitor the energy storage level of energy storage device 64. Based on the energy storage level of energy storage device 64, controls 65 may operate power regulator 60 to supply power from power line 44 to energy storage device 64 via power line 58, power regulator 60, and power line 62.

In either line-interactive mode or double-conversion mode, energy storage device 64 may serve as a backup power supply if power source 28 should fail for some reason. Accordingly, during operation of uninterruptible power supply 10 in line-interactive or double-conversion mode, controls 65 may monitor for signs that power source 28 has failed. For example, controls 65 may monitor the voltage and/or current in one or more of the power lines of uninterruptible power supply 10, and if the monitored voltage or current falls outside acceptable levels, controls 65 may surmise that power source 28 has failed. When this happens, controls 65 may operate power regulator 60 to supply power from energy storage device 64 to power line 44, and controls 65 may operate inverter 46 to supply electricity from power line 44 to output 13 to maintain substantially uninterrupted power to load 12.

In some circumstances, uninterruptible power supply 10 may supply electricity from the primary power source 28 to output 13 via emergency feed path 24 or maintenance feed path 26. Uninterruptible power supply 10 may use emergency feed path 24, for example, in the event that one of the components of double-conversion feed path 20 or line-interactive feed path 22 fails. For instance, if inverter 46 fails, controls 65 may control static switch 86 to its closed operating state to commence supply of electricity from power source 28 to output 13 via emergency feed path 24.

Maintenance feed path 26 may be used to supply electricity to output 13 when it is desired to continue power supply to load 12 while performing maintenance on one or more components of double-conversion feed path 20 and/or line interactive feed path 22. For example, if an operator of uninterruptible power supply 10 decides to perform such maintenance, the operator may employ operator interface 74 to communicate a desire to enter a maintenance mode. In response, controls 65 may close circuit breaker 92 to supply power via maintenance feed path 26. Controls 65 may also deactivate double-conversion power feed path 20 and line-interactive feed path 22 by opening switches 56 and 82, as well as deactivating rectifier 42 and inverter 46.

Operation of uninterruptible power supply 10 is not limited to the examples discussed above. For instance, in some embodiments, controls 65 may activate rectifier 42 during some or all portions of operation in line-interactive mode. In some embodiments and/or circumstances, rectifier 42 may serve to supply power to power line 44 for transmission to energy storage device 64 during line-interactive mode. Also, in addition to, or instead of, switching between line-interactive mode and double-conversion mode in response to an operator request to do so, controls 65 may switch between these modes automatically.

The disclosed embodiments may provide a number of advantages. For example, switching between line-interactive and double-conversion modes based on operator inputs may allow the operator to control uninterruptible power supply 10 in a manner that furthers the objectives the operator currently views as most important. Line-interactive mode may provide greater energy efficiency than double-conversion mode because line-interactive mode transmits power to output 13 with less conversion. On the other hand, because double-conversion mode allows inverter 46 to fully control all characteristics of the electricity supplied to output 13, double-conversion mode may ensure higher quality electricity supplied to load 12. Giving the operator manual control over the operating mode of uninterruptible power supply 10 may allow the operator to tailor operation of the system to the prevailing needs at any given time.

Additionally, maintaining inverter 46 active to condition the electricity at output 13 during line-interactive mode may provide certain advantages. With inverter 46 operating in this manner during line-interactive mode, it may be possible to provide fast, relatively seemless transfer between line-interactive mode and double-conversion mode. With inverter 46 already online during line-interactive mode, inverter 46 may be able to pick up the load 12 very quickly and with relatively little disturbance in the supplied electricity. Maintaining inverter 46 active during line-interactive mode may similarly provide for relatively fast, seamless transition to supplying power from energy storage device 64 in the event power source 28 fails.

One application that may capitalize on the foregoing features of uninterruptible power supply 10 is an application where power source 28 includes an engine driving a variable-speed electric generator and power load 12 requires AC electricity. In such an application, when the engine of power source 28 is coming up to speed and the frequency of the generated electricity is below the frequency required by power load 12, uninterruptible power supply 10 may operate in double-conversion mode to allow modifying the frequency of the generated electricity to that required by power load 12. After the engine reaches a speed such that the frequency of the generated electricity is adequate for power load 12, uninterruptible power supply 10 may be transitioned to supplying electricity via line-interactive feed path 22 to capitalize on the efficiency offered by this feed path. While supplying electricity via line-interactive feed path 22, uninterruptible power supply 10 may operate inverter 46 to condition electricity supplied to power load 12. Additionally, when a step increase in the power required by power load 12 occurs, inverter 46 may use electricity from energy storage device 64 to assist the engine and generator in meeting the needs of power load 12 until the engine and generator can increase power output to meet the increased needs of power load 12.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the systems and methods disclosed herein. It is intended that the specification and examples be considered as exemplary only, with a true scope of the disclosure being indicated by the following claims and their equivalents.

What is claimed is:

1. An uninterruptible power supply, comprising:
an input;
an output;
a first power path between the input and the output;
a second power path between the input and the output, the second power path including:
a rectifier; and
an inverter; and
controls configured to operate the uninterruptible power supply to supply electricity to the output, including:
selectively operating in a first mode by transmitting electricity from the inlet to the outlet via the first power path while operating the inverter to condition at least one characteristic of electricity at the output, and
selectively operating in a second mode by transmitting electricity from the input to the output via the second power path.

2. The uninterruptible power supply of claim 1, wherein the controls are further configured to switch from operating in the first mode to operating in the second mode by:
commencing supply of electricity from the input to the rectifier, and from the rectifier to the inverter;
operating the inverter to supply electricity to the output when the inverter receives electricity from the rectifier; and
discontinuing supply of electricity from the input to the output via the first power path.

3. The uninterruptible power supply of claim 1, wherein the controls are further configured to:
receive an operator request to switch between the first mode and the second mode, and
switch between the first mode and the second mode in response to the operator request.

4. The uninterruptible power supply of claim 1, wherein transmitting electricity from the inlet to the outlet via the second power path when operating in the second mode includes:
transmitting electricity from the input to the rectifier;
transmitting electricity from the rectifier to the inverter; and
transmitting electricity from the inverter to the output.

5. The uninterruptible power supply of claim 1, wherein transmitting electricity from the inlet to the outlet via the second power path when operating in the second mode includes:
transmitting AC electricity from the input to the rectifier;
transmitting DC electricity from the rectifier to the inverter; and
transmitting AC electricity from the inverter to the output.

6. The uninterruptible power supply of claim 1, further comprising:
an energy-storage device; and
wherein operating in the second mode further includes monitoring an energy storage level of the energy storage device.

7. The uninterruptible power supply of claim 6, wherein operating in the second mode further includes selectively supplying power from the second power path to the energy storage device based on the energy storage level of the energy storage device.

8. The uninterruptible power supply of claim 1, further comprising:
an energy-storage device; and
wherein operating in the first mode further includes monitoring an energy storage level of the energy storage device.

9. The uninterruptible power supply of claim 8, wherein operating in the first mode further includes selectively supplying power from the first power path to the energy storage device via the inverter based on the energy storage level of the energy storage device.

10. An uninterruptible power supply, comprising:
an input;
an output;
a first power path between the input and the output;
a second power path between the input and the output, the second power path including:
a rectifier;
an inverter;
controls configured to operate the uninterruptible power supply to supply electricity to the output, including:
selectively operating in a first mode by transmitting electricity from the inlet to the outlet via the first power path,
selectively operating in a second mode by transmitting electricity from the inlet to the outlet via the second power path,
receiving an operator request to switch between the first mode and the second mode, and
switching between the first mode and the second mode in response to the operator request.

11. The uninterruptible power supply of claim 10, wherein switching between the first mode and the second mode in response to the operator request includes:
commencing supply of electricity from the input to the rectifier, and from the rectifier to the inverter;
operating the inverter to supply electricity to the output when the inverter receives electricity from the rectifier; and
discontinuing supply of electricity from the input to the output via the first power path.

12. The uninterruptible power supply of claim 11, wherein transmitting electricity from the inlet to the outlet via the second power path when operating in the second mode includes:
transmitting AC electricity from the input to the rectifier;
transmitting DC electricity from the rectifier to the inverter; and
transmitting AC electricity from the inverter to the output.

13. The uninterruptible power supply of claim 11, further comprising:
an energy-storage device; and
wherein operating in the second mode further includes monitoring an energy storage level of the energy storage device.

14. The uninterruptible power supply of claim 13, wherein operating in the second mode further includes selectively supplying power from the second power path to the energy storage device based on the energy storage level of the energy storage device.

15. The uninterruptible power supply of claim 1, further comprising:
an energy-storage device; and
wherein operating in the first mode further includes monitoring an energy storage level of the energy storage device.

16. The uninterruptible power supply of claim 15, wherein operating in the first mode further includes selectively supplying power from the first power path to the energy storage device via the inverter based on the energy storage level of the energy storage device.

17. A method of operating an uninterruptible power supply, the method comprising:
selectively operating the uninterruptible power supply in a first mode, including supplying electricity from an input of the uninterruptible power supply to an output of the uninterruptible power supply via a first power path;
selectively operating the uninterruptible power supply in a second mode, including supplying electricity from the input to the output via a second power path, including supplying electricity from the input to a rectifier, supplying electricity from the rectifier to an inverter, and supplying electricity from the inverter to the output;
receiving an operator request to switch between the first mode and the second mode; and
switching between the first mode and the second mode in response to the operator request.

18. The method of claim 17, wherein switching between the first mode and the second mode in response to the operator request includes:
commencing supply of electricity from the input, to the rectifier, and from the rectifier to the inverter;
operating the inverter to supply electricity to the output when the inverter receives electricity from the rectifier; and
discontinuing supply of electricity from the input to the output via the first power path.

19. The method of claim 17, wherein transmitting electricity from the inlet to the outlet via the second power path when operating in the second mode includes:
transmitting AC electricity from the input to the rectifier;
transmitting DC electricity from the rectifier to the inverter; and
transmitting AC electricity from the inverter to the output.

20. The method of claim 17, wherein operating in the second mode further includes:
monitoring an energy storage level of the energy storage device; and
selectively supplying power from the second power path to the energy storage device based on the energy storage level of the energy storage device.
